(19) United States
(12) Patent Application Publication
(10) Pub. No.: US 2003/0206654 A1
(43) Pub. Date: Nov. 6, 2003

(54) Replacing method of an object in a dynamic image

(76) Inventor: Heng-Tun Teng, Tao-Yuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/135,532

(22) Filed: May 1, 2002

(51) Int. Cl. G06K 9/00; G09G 5/00; G06K 9/36

(52) U.S. Cl. 382/181; 345/629; 382/284

(57) ABSTRACT

The present invention relates to a replacing method of an object in a dynamic image, wherein the dynamic image is a dynamic image file or a real time dynamic image. The replacing method of the present invention is to replace an object of the dynamic image by using a program, wherein the program comprises the first database, the second database, and a user interface. Saved contents of the first database are plural characteristics of the first object which will be replaced, in the dynamic image. Saved content of the second database is the second object, which will be used to replace the first object. When the dynamic image is showed, the program of the present invention will start to detect the first objects, which are in the dynamic image, by using the plural characteristics of the first objects and will start to proceed an object characteristic comparing procedure. In the object characteristic comparing procedure, the program of the present invention uses a similar rate to detect and adjust the first objects, which are in the dynamic image. When a similar rate of an object, which is detected from the dynamic image, is higher than a set value, the object is belong to the first object. Then the second objects, which are saved in the second database, will replace the first objects, which are showing in the dynamic image. In the showing dynamic image procedure, a user can use the user interface to get a static image, whose first object is replaced by using the second object.

### BACKGROUND OF THE INVENTION

1. Field of the Invention

The present invention relates to a replacing method of an object in an image, more particularly, to a replacing method of an object in a dynamic image to provide more choices for users in replacing objects that are in the dynamic image and to provide more amusement effect for the users, wherein the dynamic image is a dynamic image file or a real time dynamic image.

2. Description of the Prior Art

For present information users, especially to the personal computer users, a mode of the computer information has been changed from an unexciting word mode to a multi-media mode. The multi-media mode means that the information comprises words, images, and sounds. In order to show the multi-media mode in the face of viewers, various multi-media devices, which can collect the images and sounds, are developed. Because the multi-media information comprises more matters, memories, which are used to deal with the multi-media information, are greater than memories, which are used to deal with the unexciting word information to show the multi-media information more smoothly.

For an input image device, scanners, digital video cameras, and digital cameras are the common devices at the present day. The digital camera uses digital information to save the static image, which is got from shooting a scene on a location. The digital video camera uses digital information to save the dynamic image, which is got from shooting a scene on a location. Image data of the static image or the dynamic image are usually saved in a floppy disk card or a personal computer memory card international association (PCMCIA) card. In order to decrease the memory of saving multi-media information, the images, which are got from shooting a scene on a location by using a digital camera, are saved by using compression files. The file format of a joint photographic experts group (JPEG) mode is common used in the static image compression files. The AVI multimedia file format is usually used in the digital video camera to save its dynamic image data.

AVI multimedia file format is researched and developed by Microsoft to definite a file format of video files for Windows. The files, which are belong to the AVI multimedia file format, can be used to save many different kinds medium data streams. Each data stream is a an independent medium, such as image data stream, video stream, word stream, etc. A showing applied program, which is used to show the AVI multimedia file, has to show the data streams synchronously. Therefore, the AVI multimedia file format is one of the important file format in the medium field.

The AVI multimedia file will not be showed by using special computer hardware and will be showed by a common personal computer. Therefore, the circulate rate of the AVI multimedia file is more quickly. Because this kind of file divides the dynamic image to become pieces of static image and later image only save differences between the later image and forgoing image, the partial pixels are compared before the dynamic image is showed. The showing rate of the AVI multimedia file is about 20 tableaus and the size of the tableaus is about half of a monitor.

In general, a file, which is saved in the digital video camera, is saved to become the AVI multimedia file after the file is transmitted from the digital video camera to a computer. When a charge-coupled device (CCD) is connected to a computer, a real time dynamic image will be showed on the monitor. The charge-coupled device is a kind of circuits, which can sense for light. The digital camera and the digital video camera just use the images, which retain on the charge-coupled device, to transform the light sensitivity of each object to become digital data. Then the digital data is saved in a memory of the digital camera or the digital video camera.

In the traditional method, when the dynamic image, whose format is a multimedia file format, is showed on the monitor, a mist procedure is used to hide partial objects, which are in the dynamic image and the user wants to hide them, such as face of a person, and to make viewers not watch the real appearances of the partial objects clearly. The mist format is on top of the partial objects. But this mist procedure cannot be used in the real time dynamic image and the mist format cannot fully protect the real appearance of the partial objects because of the set value of the mist format degree. This mist format can also be removed by using software or a hardware easily to lose a meaning of hiding partial objects. Therefore, using the traditional method to hide partial objects by using the mist procedure may cause inconvenience for users and cannot achieve an amusement effect.

### SUMMARY OF THE INVENTION

In accordance with the background of the above-mentioned invention, the traditional mist procedure cannot hide the partial objects, which is in the dynamic image, actually. The present invention provides a method to hide the partial objects, which is in the dynamic image, actually by identifying characteristics and replacing objects in a database to replace the partial objects, which is in the dynamic image, wherein the dynamic image is a dynamic image file or a real time dynamic image.

The second objective of the present invention is to increase the amusement effect of the dynamic image by identifying characteristics and replacing objects in a database to replace the partial objects, which is in the dynamic image, wherein the dynamic image is a dynamic image file or a real time dynamic image.

The third objective of the present invention is to protect the personal secrets adequately by identifying characteristics and replacing objects in a database to replace the partial objects, which is in the dynamic image, wherein the dynamic image is a dynamic image file or a real time dynamic image.

The further objective of the present invention is to increase the efficiency of the image procedure by identifying characteristics and replacing objects in a database to replace the partial objects, which is in the dynamic image, wherein the dynamic image is a dynamic image file or a real time dynamic image.

In according to the foregoing objectives, the present invention provides a method to hide the partial objects, which is in the dynamic image, actually by identifying characteristics and replacing objects in a database to replace the partial objects, which is in the dynamic image, wherein the dynamic image is a dynamic image file or a real time dynamic image. The replacing method of the present invention is to replace an object of the dynamic image by using a program, wherein the program comprises the first database, the second database, and a user interface. Saved contents of the first database are plural characteristics of the first object, which will be replaced in the dynamic image. Saved content of the second database is the second object, which will be used to replace the first object. When the dynamic image is showed, the program of the present invention will start to detect the first objects, which are in the dynamic image, by using the plural characteristics of the first objects and will start to proceed an object characteristic comparing procedure. In the object characteristic comparing procedure, the program of the present invention uses a similar rate to detect and adjust the first objects, which are in the dynamic image. When a similar rate of an object, which is detected from the dynamic image, is higher than a set value, the object is belong to the first object. Then the second objects, which are saved in the second database, will replace the first objects, which are showing in the dynamic image. In the showing dynamic image procedure, a user can use the user interface to get a static image, whose first object is replaced by using the second object. The present invention can also increase the amusement effect of the dynamic image and protect the personal secrets adequately. The present invention can further increase the efficiency of the image procedure.

### BRIEF DESCRIPTION OF THE DRAWINGS

In the accompanying drawing forming a material part of this description, there is shown:

FIG. 1 is the first flowchart of the present invention; and

FIG. 2 is the second flowchart of the present invention.

### DESCRIPTION OF THE PREFERRED EMBODIMENT

The foregoing aspects and many of the intended advantages of this invention will become more readily appreciated as the same becomes better understood by reference to the following detailed description, when taken in conjunction with the accompanying drawings, wherein:

The present invention provides a method to hide the partial objects, which is in the dynamic image, actually by identifying characteristics and replacing objects in a database to replace the partial objects, which is in the dynamic image, wherein the dynamic image is a dynamic image file or a real time dynamic image. The replacing method of the present invention is to replace an object of the dynamic image by using a program, wherein the program comprises the first database, the second database, and a user interface. Saved contents of the first database are plural characteristics of the first object, which will be replaced in the dynamic image. Saved content of the second database is the second object, which will be used to replace the first object.

When a user wants to use the present invention to replace the partial objects, which are in the dynamic image, the user must install a program of the present invention method into a computer and drive the program. Then the user can select the first objects, which he or she wants to replace in the dynamic image, and the second objects, which are used to replace the first object, in the user interface. When the first objects are the plural different objects, the user can also select plural different second objects in turn in the user interface to be corresponding to the plural different first objects.

Then the dynamic image file, such as AVI multimedia format file, or a real time dynamic image that is showed on a monitor by using the charge-coupled device, is executed by using a showing program. When the dynamic image is showed, the program of the present invention will start to detect the first objects, which are in the dynamic image, by using the plural characteristics of the first objects and will start to proceed an object characteristic comparing procedure. In the object characteristic comparing procedure, the program of the present invention uses a similar rate to detect and adjust the first objects, which are in the dynamic image. When a similar rate of the third object, which is detected from the dynamic image, is higher than a set value, the third object is belong to the first object. Then the second objects, which are saved in the second database, will replace the first objects, which are showing in the dynamic image. The similar value is a kind of compared difference between the first object and the third object. In the showing dynamic image procedure, a user can use the user interface to get a static image, whose first object is replaced by using the second object. After finishing to show the dynamic image, the user can select to save a dynamic image if the dynamic image which comprises the first objects is replaced by the dynamic image which comprises the second objects or not. When the first objects are the plural different first objects and different first objects must be replaced by the different second objects, the plural different first objects are classified by the moving trajectories of the plural different first objects and each identical type of first objects are replaced by the identical type of the second objects.

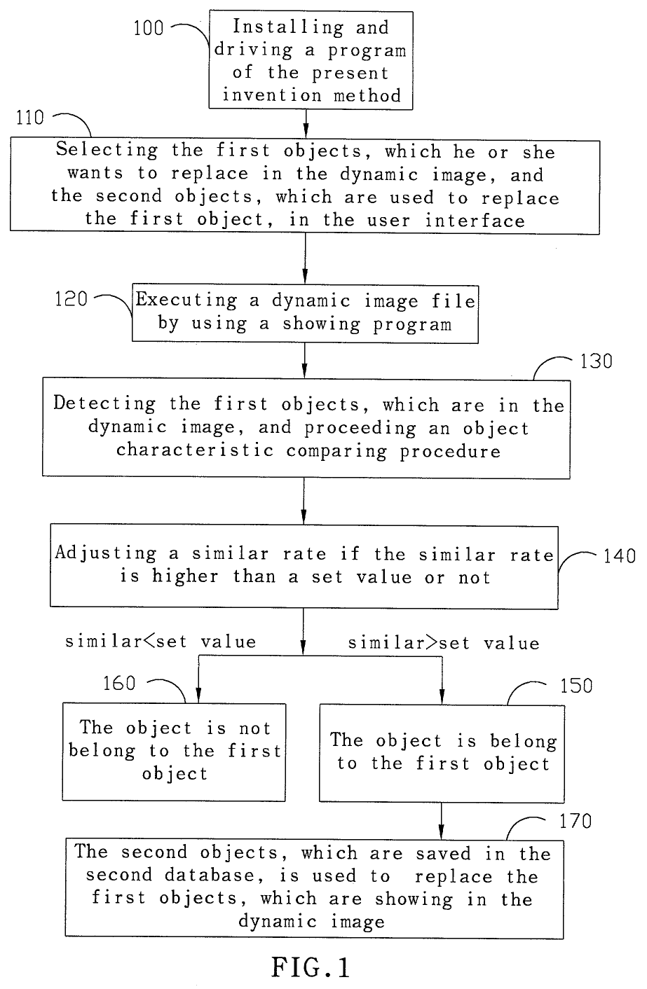

Referring to FIG. 1, this shows the first flowchart of the present invention. At first, the user must install and drive a program of the present invention method 100. Then the user can select the first objects, which he or she wants to replace in the dynamic image, and the second objects, which are used to replace the first object, in the user interface 110. When the first objects are the plural different objects, the user can also select plural different second objects in turn in the user interface to be corresponding to the plural different first objects. Then the dynamic image file, such as AVI multimedia format file, or a real time dynamic image that is showed on a monitor by using the charge-coupled device, is executed by using a showing program 120. When the dynamic image is showed, the program of the present invention will start to detect the first objects, which are in the dynamic image, by using the plural characteristics of the first objects and will start to proceed an object characteristic comparing procedure 130. In the object characteristic comparing procedure, the program of the present invention uses a similar rate to detect the first objects, which are in the dynamic image, and adjust if the similar rate is higher than a set value or not 140. When the similar rate of the third object, which is detected from the dynamic image, is higher than the set value, the third object is belong to the first object 150. When the similar rate of the third object, which is detected from the dynamic image, is lower than the set value, the third object is not belong to the first object 160. Then the second objects, which are saved in the second database, will replace the first objects, which are showing in the dynamic image 170.

Following description is one embodiment of the present invention method to replace partial objects, which are in the dynamic image, wherein the dynamic image is dynamic image file or a real time dynamic image. The following embodiment will not limit a scope of the present invention.

In usual, the dynamic image comprises the people tableaus. If people, which are in the tableaus, want to hide their true face and don't want to let viewers identify them, the faces of the people in the dynamic image are processed the mist procedure to make viewers not identify the true face of the people in traditional. But the mist is easily moved away and is easily to destroy the whole beautiful of the image. Therefore, the present invention method must be used to increase the amusement effect and whole beautiful of the dynamic image and protect the personal secrets adequately.

At first, the user must install a program of the present invention method into a computer and drive the program. Then the user can select the only one kind pattern or the plural kinds patterns from the second database by using the user interface to replace faces of people, which are in the dynamic image. The patterns, which are saved in the second database, are the faces of animals to increase the showing amusement effect. If there is only one person in the dynamic image, the user just select only one pattern on the user interface to replace the face of the person in the dynamic image in the following steps. If there are plural people in the dynamic image, the user can select plural kinds of patterns on the user interface in turn to replace the faces of the plural people in the dynamic image in the following steps. The user can just select only one pattern on the user interface to replace the faces of the plural people in the dynamic image in the following steps.

Then the dynamic image file, such as AVI multimedia format file, or a real time dynamic image that is showed on a monitor by using the charge-coupled device, is executed by using a showing program. When the dynamic image is showed, the program of the present invention will start to detect the faces of the people, which are in the dynamic image, by using the plural characteristics of the faces of the people and will start to proceed a similar rate comparing procedure. The characteristics in the first database are the characteristics of the faces of the people, such as the color of skin, locations of the facial features, and the color of eyes etc. in the detecting faces procedure, the similar rate comparing procedure is proceed at the same time. When the similar rate of an object, which is detected from the dynamic image, is higher than a set value, the object is belong to the faces of the people. When the similar rate of an object, which is detected from the dynamic image, is lower than a set value, the object is not belong to the faces of the people. The similar value is a kind of compared difference between the characteristics of the faces of the people and the object. When there are the plural different faces in the dynamic image, the plural different faces are classified by different moving trajectories of the plural different faces and each identical type of plural faces are replaced by the identical type of the patterns in turn.

After identifying the plural faces of the people from the dynamic image, the patterns, which are saved in the second database and are selected by the users from the user interface, will replace the faces of the people, which are showing in the dynamic image. The viewers just can watch the dynamic image whose partial faces are replaced by the selected patterns and cannot discover the true faces of the people in the dynamic image. Following different needs of the user, the user can use the user interface of the present invention to get a static image, whose faces of the people are replaced by using the patterns. After finishing to show the dynamic image, the user can select to save a dynamic image if the dynamic image which comprises the faces of the people is replaced by the dynamic image which comprises the patterns or not or to save a dynamic image which comprises the patterns to become a new dynamic image file. When the patterns of the second database is used to replace the faces of the people in the dynamic image, a size of the patterns, which are used to replace the faces, will be magnified and reduced automatically following the size of the faces. Therefore, the viewers will not discover the true faces of the people in the dynamic image. When the dynamic image whose faces of the people are replaced by the patterns is saved to become a new dynamic image, the locations of the faces in the dynamic image have been replaced by the patterns and other people do not know the true faces of the people from the new dynamic image by any method. Therefore, the personal secrets of the people in the dynamic image can be protected and the present invention method will increase the amusement effect.

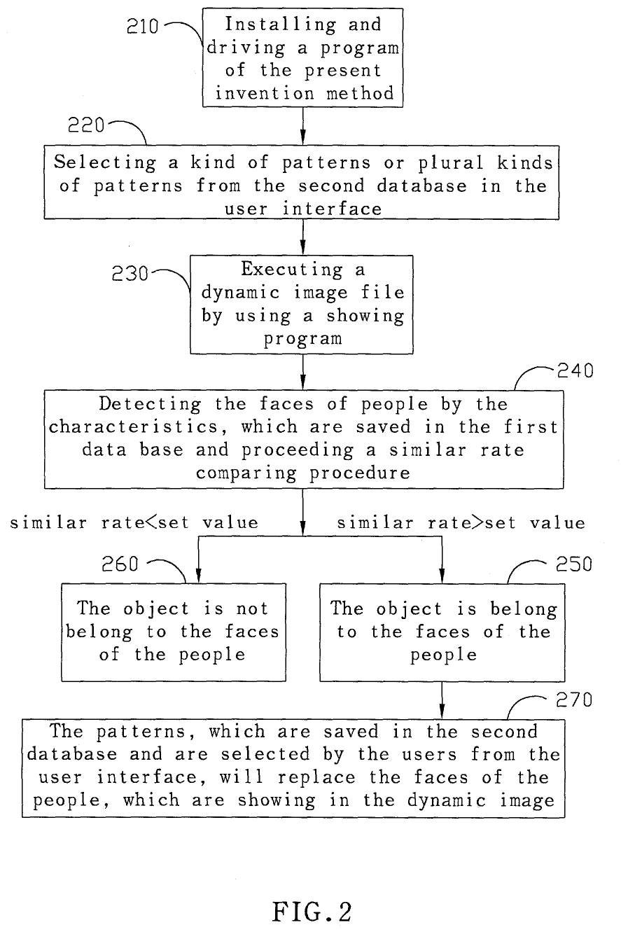

Referring to FIG. 2, this shows the second flowchart of the present invention. The second flowchart shows using the present invention method to replace the faces of the people, which are in the dynamic image, to become the patterns. At first, the user must install a program of the present invention method into a computer and drive the program 210. Then the user can select the only one kind pattern or the plural kinds patterns from the second database by using the user interface 220 to replace faces of people, which are in the dynamic image. Then the dynamic image is showed on a monitor, wherein the dynamic image is a dynamic image file or a real time dynamic image 230. When the dynamic image is showed, the program of the present invention will start to detect the faces of the people, which are in the dynamic image, by using the plural characteristics of the faces of the people and will start to proceed a similar rate comparing procedure 240. When the similar rate of an object, which is detected from the dynamic image, is higher than a set value, the object is belong to the faces of the people 250. When the similar rate of an object, which is detected from the dynamic image, is lower than a set value, the object is not belong to the faces of the people 260. When there are the plural different faces in the dynamic image, the plural different faces are classified by different moving trajectories of the plural different faces and each identical type of plural faces are replaced by the identical type of the patterns in turn. After identifying the plural faces of the people from the dynamic image, the patterns, which are saved in the second database and are selected by the users from the user interface, will replace the faces of the people, which are showing in the dynamic image 270.

In accordance with the present invention, the present invention provides a method to hide the partial objects, which is in the dynamic image, actually by identifying characteristics and replacing objects in a database to replace the partial objects, which is in the dynamic image, wherein the dynamic image is a dynamic image file or a real time dynamic image. The replacing method of the present invention is to replace an object of the dynamic image by using a program, wherein the program comprises the first database, the second database, and a user interface. Saved contents of the first database are plural characteristics of the first object, which will be replaced in the dynamic image. Saved content of the second database is the second object, which will be used to replace the first object. When the dynamic image is showed, the program of the present invention will start to detect the first objects, which are in the dynamic image, by using the plural characteristics of the first objects and will start to proceed an object characteristic comparing procedure. In the object characteristic comparing procedure, the program of the present invention uses a similar rate to detect and adjust the first objects, which are in the dynamic image. When a similar rate of an object, which is detected from the dynamic image, is higher than a set value, the object is belong to the first object. Then the second objects, which are saved in the second database, will replace the first objects, which are showing in the dynamic image. In the showing dynamic image procedure, a user can use the user interface to get a static image, whose first object is replaced by using the second object. The present invention can also increase the amusement effect of the dynamic image and protect the personal secrets adequately. The present invention can further increase the efficiency of the image procedure.

Although specific embodiments have been illustrated and described, it will be obvious to those skilled in the art that various modifications may be made without departing from what is intended to be limited solely by the appended claims.

What is claimed is:

1. A replacing method of an object in a dynamic image, wherein said method comprises:
installing a program that comprises a user interface, a first database, and a second database into a computer and driving said program, wherein said first database includes a plurality of characteristics to at least one first object and said second database includes at least one second object;
selecting a portion of said at least one first object and a portion of said at least one second object in said user interface;
showing the dynamic image on a monitor, said dynamic image having at least one third object;
detecting presence of said selected first object in the dynamic image according to the corresponding characteristics of the selected first object and a set value, by comparing difference between the third object and the characteristics of the selected first object, wherein
said first object and said third object of the dynamic image are substantially matched when the compared difference is greater than the set value;
replacing the first object of the dynamic image with said second object, therefore displaying the dynamic image having the replaced second object; and
retrieving, via the user interface, a static image corresponding to the dynamic image.

2. The method according to claim 1, wherein said plurality of characteristics are the characteristics of faces of people.

3. The method according to claim 2, wherein said characteristics of faces of the people are a color of skin.

4. The method according to claim 2, wherein said characteristics of faces of the people are locations of facial features.

5. The method according to claim 2, wherein said plural second objects are patterns of animals.

6. A replacing method of an object in a dynamic image, wherein said method comprises:
installing a program that comprises a user interface, a first database, and a second database into a computer and driving said program, wherein said first database includes a plurality of characteristics to at least one first object and said second database includes at least one second object;
selecting a portion of said at least one second object in said user interface;
showing a first dynamic image on a monitor, said first dynamic image having at least one third object;
detecting presence of said first object in the dynamic image according to the corresponding characteristics of the first object and a set value, by comparing difference between the third object and the characteristics of the first object, wherein
said first object and said third object of the dynamic image are substantially matched when the compared difference is greater than the set value;
adjusting different kinds of said at least one first object by using different kinds of plural moving trajectories of said at least one first object in said first dynamic image;
replacing the first object of the dynamic image with said selected second object and transforming said first dynamic image to become a second dynamic image, therefore displaying said second dynamic image having the replaced second object; and
saving, via the user interface, said second dynamic image in said computer.

7. The method according to claim 6, wherein said plurality of characteristics are the characteristics of faces of people.

8. The method according to claim 7, wherein said characteristics of faces of the people are a color of skin.

9. The method according to claim 7, wherein said characteristics of faces of the people are locations of facial features.

10. The method according to claim 6, wherein said first dynamic image is replaced by said second dynamic image.

11. The method according to claim 6, wherein said first dynamic image is a real time dynamic image.

12. A replacing method of an object in a dynamic image, wherein said method comprises:
installing a program that comprises a user interface, a first database, and a second database into a computer and driving said program, wherein said first database includes a plurality of characteristics to at least one face of a person and said second database includes at least one pattern;
selecting a portion of said at least one pattern in said user interface;
showing a first dynamic image on a monitor, said first dynamic image having at least one object;
detecting and adjusting said faces of people in said first dynamic image by said plural characteristics and a set value;
detecting presence of said face of said person in the dynamic image according to the corresponding characteristics of said face of said person and a set value, by comparing difference between the object and the characteristics of said face of said person, wherein
said face of said person and said object of the dynamic image are substantially matched when the compared difference is greater than the set value;
adjusting different kinds of said at least one face of said person by using different kinds of plural moving trajectories of said at least one face of said person in said first dynamic image;
replacing the face of the person of the dynamic image with said selected pattern and transforming said first dynamic image to become a second dynamic image, therefore displaying said second dynamic image having the replaced pattern; and
saving, via the user interface, said second dynamic image in said computer.

13. The method according to claim 12, wherein said characteristics to at least one face of said person are a color of skin.

14. The method according to claim 12, wherein said characteristics to at least one face of said person are locations of facial features.

15. The method according to claim 12, wherein said first dynamic image is replaced by said second dynamic image.

16. The method according to claim 12, wherein said first dynamic image is a real time dynamic image.
